(19) United States
(12) Patent Application Publication
(10) Pub. No.: US 2005/0142412 A1
(43) Pub. Date: Jun. 30, 2005

(54) Proton conducting electrolyte and fuel cell using the same

(75) Inventors: Atsuo Sonai, Yokohama (JP); Hiroyuki Nishide, Tokyo (JP); Toru Masuyama, Tokyo (JP)

Correspondence Address: MCGUIREWOODS, LLP, 1750 TYSONS BLVD, SUITE 1800, MCLEAN, VA, 22102, US

(73) Assignee: Samsung SDI Co., Ltd.

(21) Appl. No.: 11/008,611

(22) Filed: Dec. 10, 2004

(30) Foreign Application Priority Data
Dec. 11, 2003 (JP) 2003-413247
Dec. 7, 2004 (KR) 10-2004-0102209

(51) Int. Cl. H01M 8/10; C08J 5/22

(52) U.S. Cl. 429/33; 429/317; 429/314; 521/27

(57) ABSTRACT

The present invention is relates to a proton conducting electrolyte comprising a novel polymer compound having a sulfonic acid group that is widely used in the industrial field. The polymer of the present invention may be prepared by a simple reaction scheme under mild conditions. Additionally, the present invention is related to a fuel cell using the proton conducting electrolyte of the present invention. The proton conducting electrolyte may comprise at least one polymer of polysulfonatealkoxyphenyleneoxide having a backbone of polyphenyleneoxide and a side chain of sulfonatealkoxy group.

### CROSS-REFERENCE TO RELATED APPLICATIONS

This application claims priority to Japanese Patent Application No. 2003-413247, filed on Dec. 11, 2003, in the Japanese Intellectual Property Office and priority to Korean Patent Application No. 2004-102209, filed on Dec. 7, 2004, in the Korean Intellectual Property Office, the disclosures of which are incorporated herein in their entirety by reference.

### FIELD OF THE INVENTION

The present invention is related to a proton conducting electrolyte comprising a novel polymer compound and a fuel cell including the proton conducting electrolyte. More specifically, the present invention is related to a proton conducting electrolyte comprising a novel polymer compound that has high proton conductivity, better film formability, and heat resistance and can be prepared by a simple reaction scheme under mild conditions.

### BACKGROUND

Fluorinated polyethylene sulfonic acid is widely used for salt electrolysis, desalination of sea water, water treatment, and as a proton conducting membrane. Membranes which use fluorinated polyethylene sulfonic acid include, for example, Nafion, Flemion, Aciplex, and Dow membranes. Generally, these membranes are obtained by multi-stage synthesis or polymerization. However, these membranes are expensive due to fluorine. An ion exchange resin or ion exchange membrane which can be used for water treatment may also use polystyrenesulfonic acid, for example. However, the manufacturing process is used to fabricate these membranes is not environment-friendly due to sulfonation of polystyrene under the severe condition of fuming sulfuric acid.

Alternatively, membranes may use a polyphenyleneoxide derivative having heat resistance and film formability. The polyphenyleneoxide derivative may be fabricated by oxidation polymerization of a phenol derivative at room temperature in air. Phenol derivatives with electron donating group at a 2,6-position, such as 2,6-dimethylphenol, may be applied to the oxidation polymerization. However, phenol derivatives with an electron attracting group such as a carboxylic acid group or a sulfonic acid group can not be applied to the conventional oxidation polymerization for producing polyphenyleneoxide.

### SUMMARY OF THE INVENTION

The present invention is directed to a proton conducting electrolyte comprising a novel polymer compound having a sulfonic acid group that is widely used in the industrial field. Specifically, the polymer may be prepared by a simple reaction scheme under mild conditions. Additionally, the present invention is also directed to a fuel cell employing the proton conducting electrolyte.

In one aspect of the present invention, a proton conducting electrolyte may comprise one or more polymers, such as a polysulfonatealkoxyphenyleneoxide having a backbone of polyphenyleneoxide and a side chain comprising a sulfonatealkoxy group. The sulfonatealkoxy side chain allows protons to be transported thereby improving overall proton conductivity. Alternatively, the proton conducting electrolyte may be solely composed of the polysulfonatealkoxyphenyleneoxide. In particular aspect, the polysulfonatealkoxyphenyleneoxide may be used in combination with a reinforcing material, such as Teflon™, in order to increase the strength of the membrane. Furthermore, the polysulfonatealkoxyphenyleneoxide may be used in combination with a basic nitrogen-containing polymer, oxygen-containing polymer or sulfur-containing polymer to be used as an ion complex electrolyte.

The polysulfonatealkoxyphenyleneoxide in the proton conducting electrolyte may be represented Formula (1) as shown below:

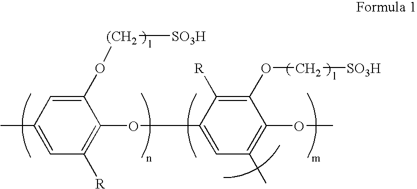

Here, R may be, for example, a hydrogen, a methyl group, or a alkyl group with greater than about 3 carbon atoms. Additionally, 1 may be about 3 or about 4, m may be an integer in the range of about 100 to about 100,000 and n may be an integer in the range of about 100 to about 100,000.

In a further aspect of the present invention, the polysulfonatealkoxyphenyleneoxide used in the proton conducting electrolyte may be prepared by an oxidation polymerization of a sulfonatealkoxyphenol. The polysulfonatealkoxyphenyleneoxide may be prepared, for example, by reacting a catechol based compound and an alkanesultone based compound to synthesize sulfonatealkoxyphenol and then oxidation polymerizing the resulting sulfonatealkoxyphenol. In a particular aspect, the catechol based compound may be 3-methylcatechol and the alkanesultone based compound may be 1,3-propanesultone. Alternatively, the catechol based compound may be catechol and the alkanesultone based compound may be 1,3-propanesultone.

A further aspect of the present invention is directed to a fuel cell comprising a pair of electrodes and an electrolyte membrane interposed between the electrodes. The electrolyte membrane may be composed of the proton conducting electrolyte of the present invention and the proton conducting electrolyte may be positioned in a part of the electrodes.

### DETAILED DESCRIPTION OF THE INVENTION

In an embodiment of the present invention, catechol based compounds may be reacted with alkanesultone based compounds to produce sulfonatealkoxyphenol in high yield. Subsequently, the sulfonatealkoxyphenol may be subjected to oxidization polymerization under mild conditions, i.e., at room temperature and in air, to produce polysulfonatealkoxyphenyleneoxide in a high yield of 90-92%. This reaction occurs due to the chemical structure of the sulfonatealkoxyphenol which comprises an electron attracting sulfonic acid group as well as a phenol core and an alkoxy group. The polysulfonatealkoxyphenyleneoxide of the present invention a has high ion exchange capacity as well as proton conductivity.

In further embodiment, the catechol based compound used as a starting material may be generally represented by Formula (1) as shown in the following reaction scheme. In Formula (1), R may be a hydrogen, a methyl group, or an alkyl group with greater than about carbon atoms, for example. In a specific embodiment, the compound may comprise catechol and 3-methylcatechol.

In another embodiment, the alkanesultone based compound may be reacted with the catechol based compound which may be generally represented by Formula (2) in the following reaction scheme as shown below. In a particular embodiment, the compound may comprise 1,3-propanesultone (where 1=3) and butanesultone (where 1=4). In a further embodiment, the base used to anionize the catechol based compound may be a strong base, such as sodium hydroxide or potassium hydroxide, for example.

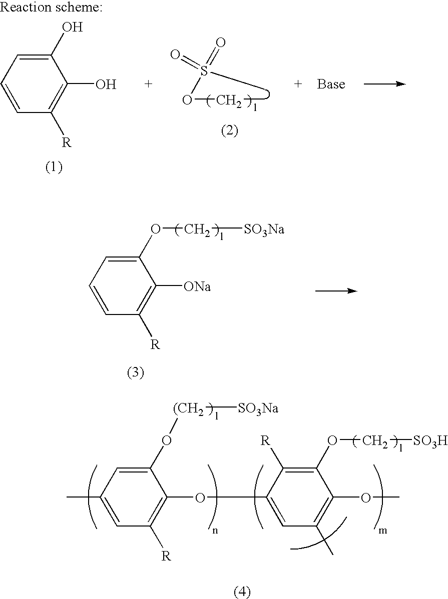

Referring to the reaction scheme above, which illustrates and embodiment of the present invention, the catechol based compound, the alkanesultone based compound and the strong base may be stirred in ethanol at room temperature or a low temperature for several hours to synthesize a monomer (i.e., sulfonatealkoxyphenol) represented by Formula (3) to be subjected to oxidation polymerization. Since only white sulfonatealkoxyphenol precipitates during the reaction, the product may be easily recovered by filtration. The unreacted catechol based compounds, the alkanesultone based compounds and the strong base may be completely removed by washing with ethanol. Even though a di-substituted catechol based compound is rarely produced due to steric hindrance, it can be prevented, nonetheless, by using the alkanesultone based compound and strong base in moles of stoichiometric amount or less with respect to the catechol based compound.

In a particular embodiment, sulfonatealkoxyphenol represented by Formula (3) may undergo oxidation polymerization by adding an oxidant to the alkaline aqueous solution and the thoroughly stirring the resultant mixture at room temperature for about 12 hours. The base used for the polymerization system may be a strong base, such as sodium hydroxide or potassium hydroxide and the amount of the base in the polymerization solution may be moles equivalent with the monomer.

Examples of the oxidant may include potassium hexacyanoferrate (III), silver oxide, lead oxide, manganese oxide, copper amine complex, iron amine complex, and manganese amine complex. In particular, when a metal oxide, such as silver oxide, is used the oxidant can be readily removed by filtration or centrifuge after the oxidation polymerization.

The obtained polysulfonatealkoxyphenyleneoxide was observed to have better heat resistance by thermogravimetric analysis and differential scanning calorimetry. In addition, the polysulfonatealkoxyphenyleneoxide is protonated (converted from sulfonate to sulfonic acid) by an acid. The polysulfonatealkoxyphenyleneoxide solution may then be cast on a Teflon™ plate and dried under reduced pressure to obtain a poly(sulfonatealkoxyphenyleneoxide) membrane as an independent structure.

A fuel cell according to an embodiment of the present invention may comprise a pair of electrodes and an electrolyte membrane interposed between the electrodes. Particularly, the electrolyte membrane may be composed of the proton conducting electrolyte of the present invention and the proton conducting electrolyte may be positioned in a part of the electrodes.

Accordingly, since the fuel cell includes the proton conducting electrolyte with better proton conductivity as an electrolyte membrane and the proton conducting electrolyte is also included in a part of the electrodes, the internal impedance of the fuel cell can be reduced and the current density can be increased. In particular, since the proton conducting electrolyte is contained in a part of the electrodes, protons can be readily transported to the inside of the electrodes, internal resistance of the electrodes can be reduced and reaction area can be increased.

### EXAMPLES

### Specific Example 1

0.58 g (2 mmol) of sodium methylsulfonatepropoxyphenol was dissolved in 100 ml of an aqueous solution of 80 mg (2 mmol) of sodium hydroxide and 0.93 g (4 mmol) of silver oxide was added as an oxidant. Then, the mixture was thoroughly stirred at room temperature. The solution turned brown immediately after adding silver oxide. After stirring for 12 hours, silver oxide was filtered off from the solution. Then, water was decanted off under reduced pressure to obtain a pale yellow powder. Then, the obtained powder was washed with ethanol to remove the sodium hydroxide. The washed powder was dissolved in 0.5 ml of water and 500 ml of ethanol was added. Then, the precipitate was collected by filtration, and then washed with ethanol to obtain 0.41 g of white powder (yield: 77%).

The obtained white powder was identified. Characterization by IR spectrum showed that the sulfonic acid group induced strong absorptions (1196 cm⁻¹, 1060 cm⁻¹ (v_{SO2})) and phenyleneether induced absorption (1273 cm⁻¹ (v_{C-O-C})). In ¹H-NMR spectrum, peaks at 6.02-6.56 ppm (m, 2H), 3.58 ppm (t, 2H), 2.86 ppm (t, 2H), 1.86 ppm (m, 2H), and 1.80 ppm (s, 3H) were also observed. Thus, the white powder was confirmed to be sodium poly(methylsulfonatepropoxyphenyleneoxide). The molecular weight was 3,200 (GPC, polystyrene standard, eluant: chloroform).

The obtained white powder (polymer) was subjected to thermogravimetric analysis and differential scanning calorimetry. As a result, the 10% pyrolysis temperature (T_{d10%}) was about 253° C. and the glass transition temperature (T_{g}) was about 115° C. Then, 0.27 g of the obtained white powder (sodium poly(methylsulfonatepropoxyphenyleneoxide)) was dissolved in 10 ml of pure water and 0.5 ml of 35% hydrochloric acid was added. The resulting solution was stirred for 10 minutes to perform protonation. Ionic exchange capacity of the protonated polymer was about 4.10 meqg⁻¹.

An aqueous solution of the polymer was cast on a Teflon™ plate and dried under reduced pressure to obtain a flexible and tough poly(methylsulfonatepropoxyphenyleneoxide) membrane with a thickness of about 60 μm. This membrane was heated and dried at about 80° C. under reduced pressure for 1 day, and then proton conductivity was measured using a conductivity meter (Hewlett-Packard). In Cole-Cole plot, the proton conductivity was about 2.3×10⁻³ Scm⁻¹ at 20° C. Accordingly, the proton conducting electrolyte composed of the poly(methylsulfonatepropoxyphenyleneoxide) membrane obtained in the present Example had high proton conductivity.

### Specific Example 2

1.24 g (10 mmol) of 3-methylcatechol was dissolved in 50 ml of ethanol and 50 ml of ethanol solution of 0.32 g (8 mmol) of sodium hydroxide was added dropwise to the solution while cooling with dry ice/ethanol under a nitrogen atmosphere. After 1 hour, 25 ml of ethanol solution of 0.98 g (8 mmol) of 1,3-propanesultone was added dropwise and slowly warmed up to room temperature. After 12 hours, the white precipitate that was not dissolved in ethanol was filtered, washed with ethanol, and dried under reduced pressure. Then, the resultant mixture was recrystallized in a mixed solvent of ethanol/water (10/1, v/v) to obtain 1.20 g of white powder (yield: 52%).

The obtained white powder was identified. As a result, in IR spectrum, ether bond induced absorption (1282 cm⁻¹ (v_{C-O-C})) and sulfonic acid group induced absorptions (1196 cm⁻¹, 1060 cm⁻¹ (v_{SO2})) were observed. In ¹H-NMR spectrum, peaks at 6.34-6.68 ppm (m, 3H), 3.94 ppm (t, 2H), 2.97 ppm (t, 2H), 2.04 ppm (m, 2H), 2.00 ppm (s, 3H) were observed. In addition, ESI-MS spectrum showed 245.2 (m/e, M-2Na⁺). Thus, the white powder was confirmed to be sodium methylsulfonatepropoxyphenol.

However, this was a mixture of isomers of sodium 2-methyl-6-(3-sulfonatepropoxy)phenol and sodium 3-methyl-2-(3-sulfonatepropoxy)phenol and the desired product was not obtained.

### Specific Example 3

0.58 g (2 mmol) of sodium methylsulfonatepropoxyphenol was dissolved in 100 ml of an aqueous solution of 80 mg (2 mmol) of sodium hydroxide and 1.32 g (4 mmol) of potassium hexacyanoferrate (III) was added as an oxidant thereto. Then, the mixture was thoroughly stirred at room temperature. The solution turned brown immediately after adding potassium hexacyanoferrate (III). The reaction proceeded in homogeneous state. After stirring for 12 hours, water was decanted off under reduced pressure to obtain a pale yellow powder.

Then, the obtained powder was washed with ethanol to remove the sodium hydroxide. Subsequently, potassium hexacyanoferrate (III) was removed by column chromatography (reverse phase silica gel with an octadecylsilyl group (Wako Pure Chemical Industries, Ltd.)) using a mixed solvent of water/methanol (5/1, v/v) as an eluant (Rf: 0.8). The eluant was decanted off under reduced pressure to obtain white powder. The white powder was dissolved in 0.5 ml of water and added to 500 ml of ethanol. Then, the precipitate was collected by filtration, and then washed with ethanol to obtain 0.36 g of white powder (yield: 68%).

The obtained white powder was identified. In the IR spectrum, sulfonic acid group induced strong absorptions (1196 cm⁻¹, 1059 cm⁻¹ (v_{SO2})) and phenyleneether induced absorption (1273 cm⁻¹ (v_{C-O-C})) were observed. In ¹H-NMR spectrum, peaks at 6.05-6.60 ppm (m, 2H), 3.58 ppm (t, 2H), 2.85 ppm (t, 2H), 1.84 ppm (m, 2H), 1.80 ppm (s, 3H) were observed. Thus, the white powder was confirmed to be sodium poly(methylsulfonatepropoxyphenyleneoxide). The molecular weight was 4,000 (GPC, polystyrene standard, eluant: chloroform).

0.27 g of the obtained white powder (sodium poly(methylsulfonatepropoxyphenyleneoxide)) was dissolved in 10 ml of pure water and 0.5 ml of 35% hydrochloric acid was added. The resulting solution was stirred for 10 minutes to perform protonation. Ionic exchange capacity of the protonated polymer was about 4.10 meqg⁻¹.

An aqueous solution of the polymer was cast on a Teflon™ plate and dried under reduced pressure to obtain a flexible and tough poly(methylsulfonatepropoxyphenyleneoxide) membrane with a thickness of about 75 μm. This membrane was dried under reduced pressure, and then proton conductivity was measured in the same manner as in Example 1. As a result, the proton conductivity was about 1.4×10⁻³ Scm⁻¹ at about 20° C. Accordingly, It was shown that the proton conducting electrolyte composed of the poly(methylsulfonatepropoxyphenyleneoxide) membrane obtained in present Example had high proton conductivity.

### Specific Example 4

1.10 g (10 mmol) of a catechol was dissolved in 50 ml of ethanol and 50 ml of an ethanol solution of 0.32 g (8 mmol) of sodium hydroxide was added dropwise to the solution while cooling with dry ice/ethanol under a nitrogen atmosphere. After 1 hour, 25 ml of an ethanol solution of 0.98 g (8 mmol) of 1,3-propanesultone was added dropwise and slowly warmed up to room temperature. After 12 hours, the white precipitate that was not dissolved in ethanol was filtered, washed with ethanol, and dried under reduced pressure. Then, the resultant mixture was recrystallized in a mixed solvent of ethanol/water to obtain 1.10 g of white powder (yield: 50%).

The obtained white powder was identified. In the IR spectrum, ether bond induced absorption (1284 cm⁻¹ (v_{C-O-C})) and sulfonic acid group induced absorptions (1201 cm⁻¹, 1060 cm⁻¹ (v_{SO2})) were observed. In ¹H-NMR spectrum, peaks in 6.83 ppm (d, 1H), 6.75 ppm (t, 1H), 6.63 ppm (d, 1H), 6.53 ppm (t, 1H), 3.99 ppm (t, 2H), 2.99 ppm (t, 2H), 2.07 ppm (m, 2H) were observed. In addition, ESI-MS spectrum showed 231.4 (m/e, M-2Na⁺). Thus, the obtained white powder was confirmed to be sodium 2-(3-sulfonatepropoxy)phenol.

Then, 0.55 g (2 mmol) of the identified white powder of sodium 2-(3-sulfonatepropoxy)phenol was dissolved in 100 ml of an aqueous solution of 80 mg (2 mmol) of sodium hydroxide and 0.93 g (4 mmol) of silver oxide was added as an oxidant. Then, the mixture was thoroughly stirred at room temperature. The solution turned brown immediately after adding silver oxide. After stirring for 12 hours, silver oxide was filtered off from the solution. Then, water was decanted off under reduced pressure to obtain a pale yellow powder. The obtained pale yellow powder was washed with ethanol to remove sodium hydroxide. The washed powder was dissolved in 0.5 ml of water and was added to 500 ml of ethanol. Then, the precipitate was collected by filtration, and then washed with ethanol to obtain 0.2 g of white powder (yield: 40%).

The obtained white powder was identified. In the IR spectrum, sulfonic acid group induced strong absorptions (1202 cm⁻¹, 1060 cm⁻¹ (v_{SO2})) and phenyleneether induced absorption (1284 cm⁻¹(v_{C-O-C})) were observed. In ¹H-NMR spectrum, peaks in 6.10-6.58 ppm (m, 3H), 3.56 ppm (t, 2H), 2.85 ppm (t, 2H), 1.85 ppm (m, 2H) were observed. Thus, the obtained white powder was confirmed to be sodium poly(methylsulfonatepropoxyphenyleneoxide). The molecular weight was 4,800 (GPC, polystyrene standard, eluant: chloroform). The obtained polymer was subjected to thermogravimetric analysis and differential scanning calorimetry. As a result, 10% pyrolysis temperature (T_{d10%}) was 199° C. and glass transition temperature (T_{g}) was 118° C.

Then, 0.25 g of the obtained white powder (sodium poly(methylsulfonatepropoxyphenyleneoxide)) was dissolved in 10 ml of pure water and 0.5 ml of 35% hydrochloric acid was added. The resulting solution was stirred for 10 minutes to perform protonation. Ionic exchange capacity of the protonated polymer was about 4.34 meqg⁻¹. An aqueous solution of the protonated polymer was cast on a Teflon™ plate and dried under reduced pressure to obtain a flexible and tough poly(methylsulfonatepropoxyphenyleneoxide) membrane with a thickness of about 60 μm. This membrane was dried under reduced pressure, and then proton conductivity was measured in the same manner as in Example 1. As a result, the proton conductivity was 1.0×10⁻³ Scm⁻¹ at 20° C. Accordingly, it was confirmed that the proton conducting electrolyte composed of the poly(methylsulfonatepropoxyphenyleneoxide) membrane obtained in the present Example had high proton conductivity.

### Specific Example 5

Carbon powder with 50% by mass Pt supported on carbon was added to an aqueous solution of the protonated polymer of sodium poly(methylsulfonatepropoxyphenyleneoxide) obtained in Example 4 and thoroughly stirred to obtain a suspension. A weight ratio of the carbon powder and the polymer was adjusted to be 1:1 based on the weight of solids. The suspension was coated on a carbon porous body (porosity: 75%) and dried. The resultant body was used as porous electrodes for a fuel cell.

The poly(methylsulfonatepropoxyphenyleneoxide) membrane obtained in Example 4 was interposed between a pair of the porous electrodes to obtain a unit cell. Hydrogen and air were supplied as a fuel and an oxidant, respectively, to generate electric power at about 80° C. As a result, the voltage of about 0.65 V was obtained at the open-circuit voltage of about 0.945 V and the current density of about 200 mA/cm². Accordingly, the fuel cell using the poly(methylsulfonatepropoxyphenyleneoxide) membrane and the electrode comprising this polymer component as a proton conductor has better proton conductivity and cell characteristics.

Although only poly(methylsulfonatepropoxyphenyleneoxide) was used in the above Examples, it may be used in combination with a reinforcing material, such as Teflon™, in order to improve membrane strength. In addition, the polymer can be used in combination with a nitrogen containing polymer, oxygen containing polymer or sulfur containing polymer to be used as an ion complex electrolyte.

As described above, according to the proton conducting electrolyte of the present invention, proton conductivity and heat resistance can be improved, current density of a fuel cell can be increased by using the proton conducting electrolyte in the fuel cell, and a high output power fuel cell can be formed and long lifespan of a fuel cell can be achieved.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A proton conducting electrolyte, comprising:
at least one polymer comprising a polysulfonatealkoxyphenyleneoxide having a backbone of polyphenyleneoxide and a side chain of sulfonatealkoxy group.

2. The proton conducting electrolyte of claim 1, wherein the polysulfonatealkoxyphenyleneoxide comprises: 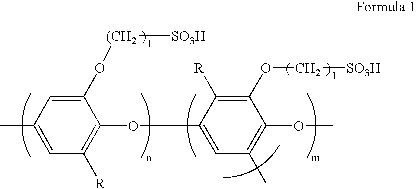
wherein:
R is selected from the group consisting of a hydrogen, a methyl group, and an alkyl group with greater than about 3 carbon atoms;
1 is selected from the group consisting of 3 and 4;
m is an integer in the range of about 100 to about 100,000; and
n is integer in the range of about 100 to about 100,000.

3. The proton conducting electrolyte of claim 1, wherein the polysulfonatealkoxyphenyleneoxide is prepared by oxidation polymerization of a monomer comprising sulfonatealkoxyphenol.

4. The proton conducting electrolyte of claim 3, wherein the polysulfonatealkoxyphenyleneoxide is prepared by reacting a catechol based compound and an alkanesultone based compound to synthesize the sulfonatealkoxyphenol and then subjecting the resulting sulfonatealkoxyphenol to an oxidation polymerization reaction.

5. The proton conducting electrolyte of claim 4, wherein the catechol based compound is 3-methylcatechol and the alkanesultone based compound is 1,3-propanesultone.

6. The proton conducting electrolyte of claim 4, wherein the catechol based compound is catechol and the alkanesultone based compound is 1,3-propanesultone.

7. A fuel cell, comprising:
a pair of electrodes; and
an electrolyte membrane interposed between the electrodes, wherein the electrolyte membrane is a proton conducting electrolyte comprising at least one polymer comprising a polysulfonatealkoxyphenyleneoxide having a backbone of polyphenyleneoxide and a side chain of sulfonatealkoxy group and the proton conducting electrolyte is contained in a part of the electrodes.

8. The fuel cell of claim 7, wherein the polysulfonatealkoxyphenyleneoxide comprises: 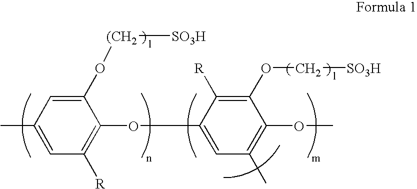
wherein:
R is selected from the group consisting of a hydrogen, a methyl group, and an alkyl group with greater than about 3 carbon atoms;
1 is selected from the group consisting of 3 and 4;
m is an integer in the range of about 100 to about 100,000; and
n is integer in the range of about 100 to about 100,000.

9. The fuel cell of claim 7, wherein the polysulfonatealkoxyphenyleneoxide is prepared by oxidation polymerization of a monomer comprising sulfonatealkoxyphenol.

10. The fuel cell of claim 9, wherein the polysulfonatealkoxyphenyleneoxide is prepared by reacting a catechol based compound and an alkanesultone based compound to synthesize the sulfonatealkoxyphenol and then subjecting the resulting sulfonatealkoxyphenol to an oxidation polymerization reaction.

11. The fuel cell of claim 10, wherein the catechol based compound is 3-methylcatechol and the alkanesultone based compound is 1,3-propanesultone.

12. The fuel cell of claim 10, wherein the catechol based compound is catechol and the alkanesultone based compound is 1,3-propanesultone.
